(19) United States
(12) Patent Application Publication
(10) Pub. No.: US 2015/0329666 A1
(43) Pub. Date: Nov. 19, 2015

(54) HYDROCARBON POLYMERS COMPRISING A 2-OXO-1,3-DIOXOLAN-4-YL END GROUP, PREPARATION AND USE THEREOF

(71) Applicant: BOSTIK SA, La Plaine St Denis (FR)

(72) Inventors: Guillaume MICHAUD, Compiegne (FR); Frederic SIMON, Pont L'Eveque (FR); Stephane FOUQUAY, Mont Saint-Aignan (FR); Liana ANNUNZIATA, Salerno (SA) (IT); Sophie GUILLAUME, Vitre (FR); Jean-Francois CARPENTIER, Acigne (FR)

(73) Assignee: BOSTIK SA, La Plaine St Denis (FR)

(21) Appl. No.: 14/650,918

(22) PCT Filed: Dec. 13, 2013
(86) PCT No.: PCT/FR2013/053076

§ 371 Date: Jun. 10, 2015

(30) Foreign Application Priority Data
Dec. 14, 2012 (FR) 1262052

(51) Int. Cl. C08G 61/08; C09J 11/08; C09J 9/00

(52) U.S. Cl. CPC C08G 61/08; C09J 9/00; C09J 11/08

(57) ABSTRACT

Process for the preparation of a hydrocarbon polymer comprising a 2-oxo-1,3-dioxolan-4-yl end group by ring opening metathesis in the presence of a metathesis catalyst, of a vinyl ethylene carbonate chain transfer agent and of a compound comprising at least one C₆-C₁₆ ring having a carbon-carbon double bond.

Hydrocarbon polymer capable of being obtained by this process.
Use of this polymer as adhesion promoter or reactive plasticizer in an adhesive composition.

A subject matter of the present invention is a process for the preparation of hydrocarbon polymers comprising a 2-oxo-1,3-dioxolan-4-yl (or CC5 or 1,3-dioxolan-2-one or cyclocarbonate) end group, of formula:

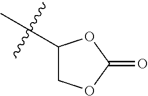 [SMILES: *C1COC(=O)O1]

The invention also relates to these hydrocarbon polymers and to the use thereof as additives, for example as adhesion promoter or reactive plasticizer.

The compounds comprising a 2-oxo-1,3-dioxolan-4-yl (CC5) end group have formed the subject of numerous publications.

Thus, (2-oxo-1,3-dioxolan-4-yl)methyloxycarbonyls (or glycerol carbonate esters), which are glycerol carbonate derivatives, exhibit advantageous properties in terms of thermal stability, of stability to oxidation, and also surfactant properties (Eur. J. Lipid Sci. Technol., 103 (2001), 216-222).

It is an aim of the present invention to provide novel polymers comprising a 2-oxo-1,3-dioxolan-4-yl end group which can be used generally as additives, preferably as adhesion promoter or reactive plasticizer, for example in hot-melt adhesives.

Thus, the present invention relates to a process for the preparation of at least one hydrocarbon polymer, said process comprising at least one stage of ring opening metathesis polymerization in the presence:
of at least one metathesis catalyst, preferably a ruthenium-comprising catalyst, more preferably still a Grubbs' catalyst,
of 4-ethenyl-1,3-dioxolan-2-one (or vinyl ethylene carbonate) as chain transfer agent (CTA), and
at least one compound chosen from compounds comprising at least one hydrocarbon ring and generally from 6 to 16, preferably from 6 to 12, carbon atoms per ring, said ring comprising at least one carbon-carbon double bond, and the substituted derivatives of this compound, said compound being of formula (7):

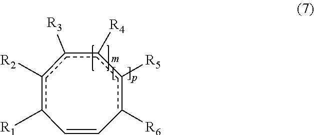

in which:
each carbon-carbon bond of the chain denoted [symbol] is a double bond or a single bond, in accord with the valency rules of organic chemistry;
the R₁ and R₆ groups are either both hydrogen or each different from hydrogen and bonded to one another as members of one and the same ring or heterocycle which is saturated or unsaturated (i.e. comprising at least one carbon-carbon double bond, including the aromatics);
the R₂, R₃, R₄ and R₅ groups are each, independently or not of the other groups, a hydrogen, a halo group, an alkoxycarbonyl group or an alkyl group, it being possible for the R₂ to R₅ groups to be bonded to one another as members of one and the same saturated or unsaturated ring or heterocycle;
m and p are integers each within a range extending from 0 to 5, the sum m+p being itself within a range from 0 to 6;
said stage being carried out for a period of time of less than or equal to 2 h, preferably from 1 hour to 2 hours.

When m=0, this means that there is no group between the square brackets to which m applies and that the two carbon-carbon bonds overlapping each one of the square brackets constitute only a single carbon-carbon bond. This likewise applies for p=0.

The molar ratio of the compound comprising at least one hydrocarbon ring to the CTA is generally within a range from 20 to 10 000 and preferably from 40 to 1000.

The compounds of formula (7) are or are not substituted. Substitution is understood to mean, according to the invention, the presence of a group, generally replacing a hydrogen, the substitution being of cyclic or acyclic alkyl type, of alkoxycarbonyl type or of halo type and the substitution preferably being located in the β, γ or δ position with respect to the carbon-carbon double bond, more preferably still in the γ or δ position with respect to the carbon-carbon double bond. Thus, the substituted derivatives of the compounds of formula (7) comprise the compounds of formula (7) comprising at least one second ring comprising at least one carbon-carbon bond in common with the first ring.

In a preferred embodiment of the invention, these compounds are not substituted, that is to say that R₁=R₂=R₃=R₄=R₅=R₆=H.

In a preferred embodiment of the invention, which is or is not independent of the preceding embodiment, m=p=1.

Ring opening metathesis polymerization (ROMP) is a reaction well known to a person skilled in the art which is here carried out in the presence of 4-ethenyl-1,3-dioxolan-2-one.

4-Ethenyl-1,3-dioxolan-2-one (or 4-vinyl-1,3-dioxolan-2-one or vinyl ethylene carbonate) is a well-known compound. It is described, for example, in the U.S. Pat. No. 2,511,942 of DuPont de Nemours (published in 1950) and in a more recent publication (US 2010/0048918 of Foosung Co.). It is used in particular as additive in the electrolytes of lithium batteries.

The cyclic compounds of formula (7) are preferably according to the invention chosen from the group formed by cycloheptene, cyclooctene, cyclononene, cyclodecene, cycloundecene, cyclododecene, 1,5-cyclooctadiene, cyclononadiene, 1,5,9-cyclodecatriene and also norbornene, norbornadiene, dicyclopentadiene, 7-oxanorbornene and 7-oxanorbornadiene respectively of formulae:

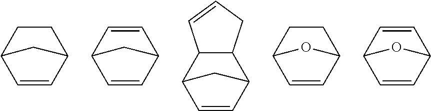

Cyclooctene (COE), norbornene and dicyclopentadiene are very particularly preferred.

Mention may also be made of the mono- or polysubstituted derivatives of these cyclic compounds, such as, preferably, alkylcyclooctenes, alkylcyclooctadienes, halocycloalkenes and alkylcarbonylcycloalkenes. In such a case, the alkyl, halo and alkoxycarbonyl groups have the meanings given above. The alkyl groups are generally in the β, γ or δ position with respect to the carbon-carbon double bond, more preferably still in the γ or δ position with respect to the carbon-carbon double bond.

The ring opening metathesis polymerization is generally carried out in the presence of at least one solvent, generally chosen from the group formed by the aqueous, organic or polar solvents typically used in polymerization reactions and which are inert under the conditions of the polymerization, such as aromatic hydrocarbons, chlorinated hydrocarbons, ethers, aliphatic hydrocarbons, water or their mixtures. A preferred solvent is chosen from the group formed by benzene, toluene, para-xylene, methylene chloride, dichloroethane, dichlorobenzene, chlorobenzene, tetrahydrofuran, diethyl ether, pentane, water and their mixtures. More preferably still, the solvent is chosen from the group formed by benzene, toluene, para-xylene, methylene chloride, dichloroethane, dichlorobenzene, chlorobenzene, tetrahydrofuran, diethyl ether, pentane and their mixtures. More particularly preferably still, the solvent is tetrahydrofuran, toluene or a mixture of toluene and methylene chloride. The solubility of the polymer formed during the polymerization reaction depends generally and mainly on the choice of the solvent and on the molar weight of the polymer obtained. It is also possible for the reaction to be carried out without solvent.

The metathesis catalyst, such as, for example, a Grubbs' catalyst, is generally a commercial product.

The metathesis catalyst is generally a transition metal catalyst, including in particular a ruthenium-catalyst comprising, generally in the form of ruthenium complex(es), such as ruthenium-carbene. Use may thus be made, particularly preferably, of Grubbs' catalysts. Grubbs' catalyst is generally understood to mean, according to the invention, a 1^{st} and 2^{nd} generation Grubbs' catalyst but also any other catalyst of Grubbs' type (comprising ruthenium-carbene) accessible to a person skilled in the art, such as, for example, the substituted Grubbs' catalysts described in the U.S. Pat. No. 5,849,851.

A 1^{st} generation Grubbs' catalyst is generally of formula (8):

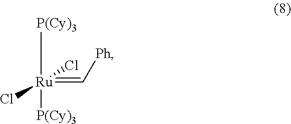

where Ph is phenyl and Cy is cyclohexyl.

The P(Cy)₃ group is a tricyclohexylphosphine group.

The IUPAC name for this compound is: benzylidene-bis(tricyclohexylphosphine)dichlororuthenium (of CAS number 172222-30-9).

A 2^{nd} generation Grubbs' catalyst is generally of formula (9):

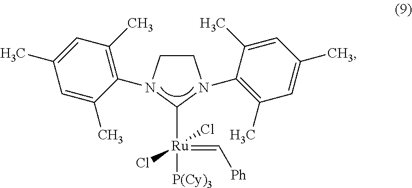

where Ph is phenyl and Cy is cyclohexyl.

The IUPAC name of the second generation of this catalyst is benzylidene[1,3-bis(2,4,6-trimethylphenyl)-2-imidazolidinylidene]dichloro(tricyclohexylphosphine)-ruthenium (of CAS number 246047-72-3).

The preparation process according to the invention can additionally comprise at least one additional stage of hydrogenation of carbon-carbon double bonds. Very obviously, this stage is carried out only on an unsaturated hydrocarbon polymer. The hydrogenation of at least one carbon-carbon double bond, preferably the complete hydrogenation of the carbon-carbon double bonds, is thus carried out.

This stage is generally carried out by catalytic hydrogenation, generally under hydrogen pressure and in the presence of a hydrogenation catalyst, such as a palladium catalyst supported by carbon (Pd/C).

The present invention also relates to any hydrocarbon polymer comprising a 2-oxo-1,3-dioxolan-4-yl end group capable of being obtained by the process according to the invention.

The present invention also relates to a hydrocarbon polymer comprising a 2-oxo-1,3-dioxolan-4-yl end group, said hydrocarbon polymer being capable of being obtained according to the process of the invention, said hydrocarbon polymer being of formula (1):

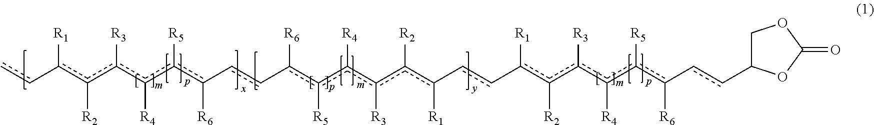

in which:
each carbon-carbon bond of the chain denoted [symbol] is a double bond or a single bond, in accord with the valency rules of organic chemistry;
the R₁ and R₆ groups are either both hydrogen or each different from hydrogen and bonded to one another as members of one and the same ring or heterocycle which is saturated or unsaturated (i.e. comprising at least one carbon-carbon double bond, including the aromatics);
the R₂, R₃, R₄ and R₅ groups are each, independently or not of the other groups, a hydrogen, a halo group, an alkoxycarbonyl group or an alkyl group, it being possible for the R₂ to R₅ groups to be bonded to one another as members of one and the same saturated or unsaturated ring or heterocycle;
m and p are integers each within a range extending from 0 to 5, the sum m+p being itself within a range from 0 to 6; and
x and y are each an integer, independently of one another, x being different from 0, the sum x+y being such that the number-average molar mass Mn of the hydrocarbon polymer of formula (1) is within a range from 400 to 50 000 g/mol, preferably from 600 to 20 000 g/mol, and the polydispersity (PDI) of the hydrocarbon polymer of formula (1) is within a range from 1.0 to 2.0, preferably from 1.1 to 1.7 and more preferably still from 1.4 to 1.7.

When y=0, this means that there is no group between the square brackets to which y applies and that the two carbon-carbon bonds overlapping each one of the square brackets constitute only a single carbon-carbon bond.

The polymer capable of being obtained by the process according to the invention is preferably a polymer of formula (1).

In addition, polymer is spoken of here but it more specifically relates to a mixture of polymers represented by the formula (1), as is well known to a person skilled in the art. In this respect, the molar masses are “average” molar masses.

The polymer of formula (1) can thus be written schematically A_{X}B_{Y}AT, where A is the monomer unit present x times, B is the monomer unit present y times and T is the end group. However, the way of writing the formula (1) is very obviously to a person skilled in the art a simplified way of writing. The copolymer Aₓ₋₁B_{y} is a copolymer having a random homogeneous structure (i.e. a copolymer composed of macromolecules in which the probability of finding a given monomer unit A or B at a given point of the chain is independent of the nature of the adjacent monomer units) or periodic homogeneous structure (i.e. a copolymer composed of macromolecules comprising two monomer units in a regular sequential order, for example an alternating order) or statistical homogeneous structure (i.e. a copolymer composed of macromolecules in which the distribution of the monomer units obeys known statistical laws). In such a polymer, only the monomer unit A is indeed present at both ends of the polymer, alone at one end or in contact with T at the other end. Without wishing to be restricted to a theory, the inventors believe that it is highly probable that the copolymer Aₓ₋₁B_{y} is a copolymer having a random homogeneous structure. The monomer units A and B are thus randomly distributed along the main chain of the polymer.

This simplified way of writing is, of course, valid for all the formulae of polymers which will be described below, including those of the examples.

Very obviously, all the formulae given here are in accord with the valency rules of organic chemistry.

In the specific case where y=0, the formula (1) becomes the following formula:

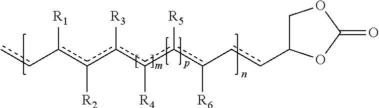

(101) with n=x+1.

Alkyl group is understood to mean, according to the invention, a linear or branched, cyclic, acyclic, heterocyclic or polycyclic hydrocarbon compound generally comprising from one to twenty-two carbon atoms. Such an alkyl group generally comprises from 1 to 4 and preferably from 1 to 2 carbon atoms.

Halo group is understood to mean, according to the invention, an iodo, chloro, bromo or fluoro group, preferably a chloro group.

Heterocycle is understood to mean, according to the invention, a ring which can comprise another atom than carbon in the chain of the ring, such as, for example, oxygen.

Alkoxycarbonyl group is understood to mean, according to the invention, a saturated or partially unsaturated, linear or branched, divalent alkyl group comprising from one to twenty-two, preferably from one to eight, more preferably still from one to six, carbon atoms and such that a chain of carbon atoms which it comprises additionally comprises a divalent —COO— group.

The polydispersity PDI (or dispersity Dₘ) is defined as the Mw/Mn ratio, that is to say the ratio of the weight-average molar mass to the number-average molar mass of the polymer.

The two average molar masses Mn and Mw are measured according to the invention by size exclusion chromatography (SEC), normally with PEG (PolyEthylene Glycol) or PS (PolyStyrene) calibration, preferably PS calibration.

End group is understood to mean a group located at the chain end (or end) of the polymer.

If it is unsaturated, the polymer according to the invention generally comprises a plurality of (i.e. more than two) carbon-carbon double bonds.

In a preferred embodiment, the polymer of formula (1) comprises only a single carbon-carbon double bond per repeat unit [ . . . ] and the polymer is of formula (1′):

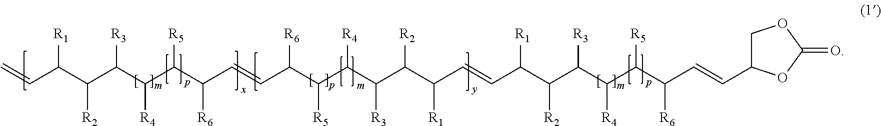

In this case, preferably, m is equal to 1 and p is equal to 1.

In the specific case where y=0, the formula (1′) becomes the following formula:

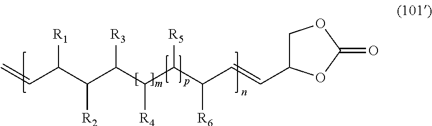

with n=x+1.

Preferably, the invention relates to a hydrocarbon polymer comprising a 2-oxo-1,3-dioxolan-4-yl end group, said hydrocarbon polymer being of formula (2) or of formula (3):

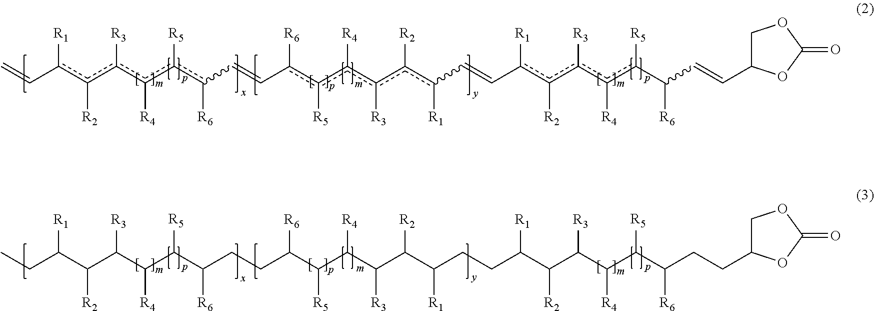

in which [symbol] , m, p, x, y, R₁, R₂, R₃, R₄, R₅ and R₆ have the meanings given above and, as is known to a person skilled in the art, the [symbol] bond means that the bond is oriented geometrically on one side or the other with respect to the double bond, i.e.: Z (for Zusammen=cis) or E (for Entgegen=trans).

Particularly preferably, m is equal to 1 and p is equal to 1.

In the specific case where y=0, the formulae (2) and (3) respectively become the following formulae:

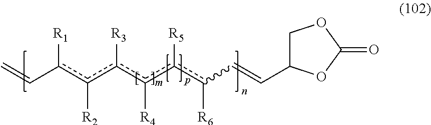

with n=x+1; and

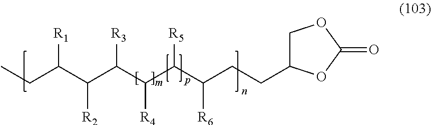

with n=x+1.

The polymer of formula (2) is generally of trans (E)-trans (E), trans (E)-cis (Z) or cis (Z)-cis (Z) orientation. The three isomers are generally present in variable proportions, generally with a majority of trans (E)-trans (E). It is possible according to the invention for the trans (E)-trans (E) isomer to be present quasi-predominantly.

The formula (2) illustrates the case where the repeat units of the main chain of the polymer of formula (1) are unsaturated and each comprise at least one carbon-carbon double bond. In a preferred embodiment, the polymer of formula (2) comprises only a single carbon-carbon double bond per repeat unit and the polymer is of formula (2′):

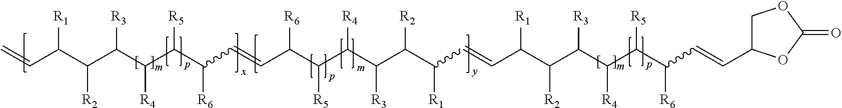

In this case, preferably, m is equal to 1 and p is equal to 1.

In the specific case where y=0, the formula (2′) becomes the following formula:

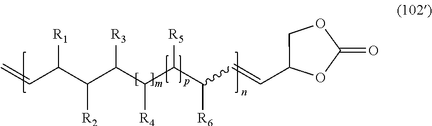

with n=x+1.

The formula (3) illustrates the case where the main chain of the polymer of formula (1) is saturated.

The polymer of formula (3) can, for example, result from the hydrogenation of the polymer of formula (2).

According to a preferred embodiment of the invention, the invention relates to a hydrocarbon polymer comprising a 2-oxo-1,3-dioxolan-4-yl end group, said hydrocarbon polymer being of formula (4):

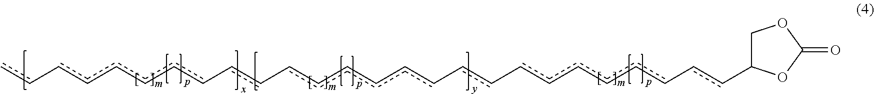

in which [symbol] , m, p, x and y have the meanings given above.

In the specific case where y=0, the formula (4) becomes the following formula:

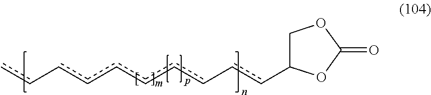

with n=x+1.

The formula (4) illustrates the case where the polymer of formula (1) is such that R₁, R₂, R₃, R₄, R₅ and R₆ are each a hydrogen (H). In a preferred embodiment, the polymer of formula (4) comprises at most only a single carbon-carbon double bond per repeat unit, and the polymer is of formula (4′):

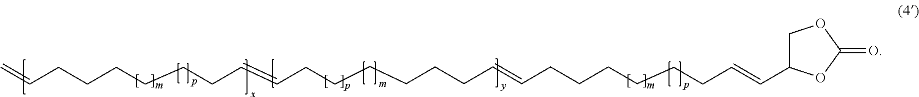

In the specific case where y=0, the formula (4′) becomes the following formula:

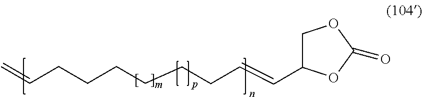

with n=x+1.

According to this embodiment, preferably, the invention relates to a hydrocarbon polymer comprising a 2-oxo-1,3-dioxolan-4-yl end group, said hydrocarbon polymer being of formula (5) or of formula (6):

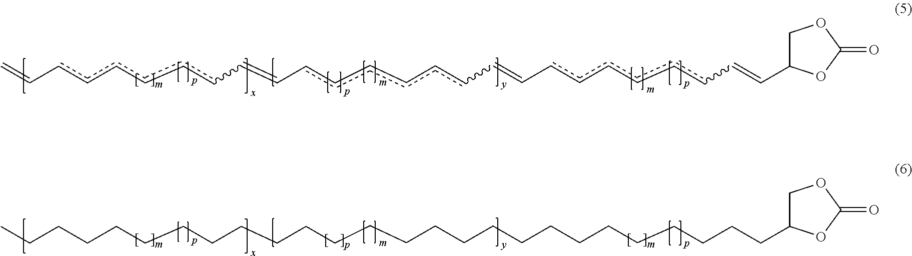

in which [symbol] , [symbol] , m, p, x and y have the meanings given above.

In the specific case where y=0, the formulae (5) and (6) respectively become the following formulae:

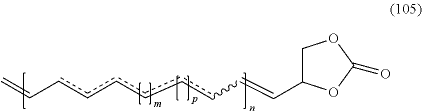

with n=x+1; and

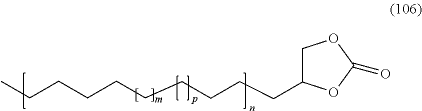

with n=x+1.

The formula (5) illustrates the case where the repeat unit of the main chain of the polymer of formula (4) is unsaturated and comprises at least one carbon-carbon double bond.

In a preferred embodiment, the polymer of formula (5) comprises only a single carbon-carbon double bond per repeat unit, and the polymer is of formula (5′). In this case, preferably, m is equal to 1 and p is equal to 1.

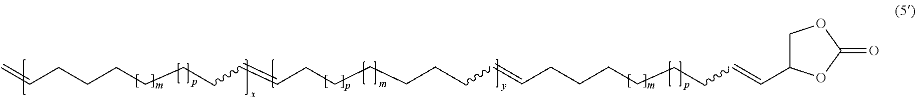

In the specific case where y=0, the formula (5′) becomes the following formula:

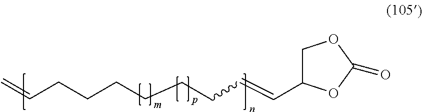

with n=x+1.

The formula (6) illustrates the case where the main chain of the polymer of formula (4) is saturated.

The polymer of formula (6) can, for example, result from the hydrogenation of the polymer of formula (5).

The formulae (5) and (6) correspond to the formulae (2) and (3) in which R₁, R₂, R₃, R₄, R₅ and R₆ are each a hydrogen (H).

Advantageously, the hydrocarbon polymer according to the invention, i.e. capable of being obtained by the process of the invention and optionally of formula (1), can be used as additive, generally:
as adhesion promoter, or
as reactive plasticizer in an adhesive composition.

The hydrocarbon polymer according to the invention can thus be used, for example, as adhesion promoter within an adhesive composition of HMA (Hot Melt Adhesive) or HMPSA (Hot Melt Pressure-Sensitive Adhesive) type based on polyolefins or on block polymers comprising styrene.

In addition, the unsaturated or saturated hydrocarbon polymers according to the invention exhibit a 2-oxo-1,3-dioxolan-4-yl end group which advantageously constitutes a polar head located close to the lipophilic polymer chain. Consequently, the addition of at least one unsaturated or saturated hydrocarbon polymer according to the invention makes it possible to reduce the interfacial tension of hot-melt compositions based on polyolefins or on block copolymers comprising styrene (HMA and HMPSA type) in their use as adhesion promoters.

The invention thus also relates to the use of at least one hydrocarbon polymer according to the invention as adhesion promoter.

The invention thus also relates to the use of at least one hydrocarbon polymer according to the invention as reactive plasticizer within an adhesive composition.

The invention will be better understood in the light of the examples which follow.

### EXAMPLES

The examples which follow illustrate the invention without, however, limiting the scope thereof.

### Experimental Protocol

All the experiments were carried out, if necessary, under an argon atmosphere.

The 4-ethenyl-1,3-dioxolan-2-one (or 4-vinyl-1,3-dioxolan-2-one or vinyl ethylene carbonate) and the 2^{nd} generation Grubbs' catalyst of formula (9) were products from Aldrich.

The cyclooctene (COE) was a product from Aldrich, which was distilled over CaH₂ and degassed before use.

The tetrahydrofuran (THF) was subjected to reflux under Na/benzophenone, distilled and degassed before use. All the other solvents were used as received.

The FTIR (Fourier Transform InfraRed) spectra were recorded on a Shimadzu IRAffinity-1 device.

The NMR spectra were recorded on AM-500 Bruker and AM-400 Bruker spectrometers, at 298 K in CDCl₃. The chemical shifts were referenced with respect to tetramethylsilane (TMS) using the (¹H) or (¹³C) resonance of the deuterated solvents. The number-average and weight-average molar masses (Mn and Mw) and the polydispersity PDI (Mw/Mn) of the polymers were determined by gel permeation chromatography (GPC) using a Polymer Laboratories PL-GPC 50 instrument. Mass spectra were recorded with a high resolution AutoFlex LT spectrometer (Bruker) equipped with a pulsed N₂ laser source (337 nm, 4 ns pulse width).

### Example 1

### Synthesis of an unsaturated polyolefin comprising a 2-oxo-1,3-dioxolan-4-yl end group from cyclooctene and the 4-ethenyl-1,3-dioxolan-2-one chain transfer agent

The synthesis reaction of example 1 was carried out by ROMP ring opening polymerization of cyclooctene (COE) in the presence of a Grubbs' catalyst and of the 4-ethenyl-1,3-dioxolan-2-one transfer agent (CTA).

The reaction was carried out according to the following scheme 1:

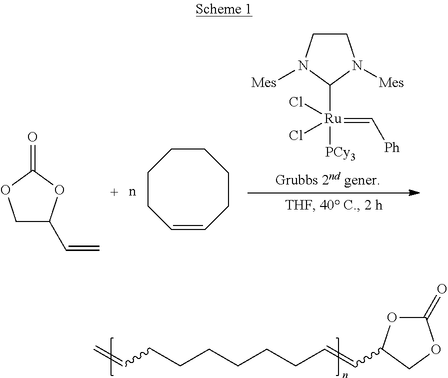

The polymerization was carried out normally according to the data below. A 100 ml flask was charged, with stirring and sequentially, with THF (tetrahydrofuran) (5 ml), COE (1.4 ml) and the appropriate amount of 4-ethenyl-1,3-dioxolan-2-one transfer agent. The resulting solution was thermostatically controlled at 40° C. and the polymerization was initiated by injection of a precatalyst solution prepared by dissolving a 2^{nd} generation Grubbs' catalyst (“Ru”) (5.0 mg) in THF (3 ml). After reacting for 2 hours, the mixture was poured into cold acidified methanol. The polymers present were recovered by filtration and dried at 25° C. under vacuum.

A compound of following formula (10) was thus synthesized according to the invention:

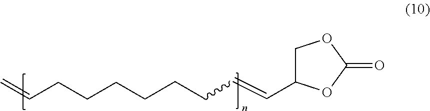

This compound (10) is a compound according to the invention of formula (105′) in which m is equal to 1 and p is equal to 1.

Various tests were carried out according to this reaction. They are summarized in table 1 below.

TABLE 1

| | [CTA]/[Ru] | [COE]/[CTA] | Conv. | Mn_{GPC} | |
|---|---|---|---|---|---|
| Test | (mol/mol) | (mol/mol) | (%) | (g/mol) | PDI |
| T1 | 5 | 400 | 100 | 56 800 | 1.62 |
| T2 | 10 | 200 | 100 | 16 800 | 1.48 |
| T3 | 20 | 100 | 100 | 8900 | 1.43 |
| T4 | 30 | 66 | 100 | 6700 | 1.41 |
| T5 | 50 | 40 | 100 | 3500 | 1.45 |
| T6 | 20 | 50 | 100 | 6500 | 1.43 |

NMR analyses of the polymer obtained in the test T4 gave the following values, which confirm the structural formula (10) of this polymer: ¹H NMR (CDCl₃, 400 MHz, 298 K): δ trans unit of the main chain: 1.30, 1.97, 5.39; δ cis unit of the main chain: 1.30, 2.03, 5.34; cyclocarbonate chain end: 4.12, 4.56 (t, 2H, —CH═CH—CH—CH₂OCOO), 5.09 (m, 1H, —CH═CH—CH—CH₂OCOO), 5.53 (dt, 1H, Jₜᵣₐₙₛ=15.0 Hz, —CH═CH—CH—CH₂OCOO), 5.97 (m, Jₜᵣₐₙₛ=14.8 Hz, J=7.0 Hz, 1H, —CH═CH—CH—CH₂OCOO), vinyl chain end: 2.14 (m, 2H, —CH₂—CH═CH₂), 4.98 (dt, J=17.7 and 10.7 Hz, 2H, —CH₂—CH═CH₂), 5.83 (m, 1H, —CH₂—CH═CH₂). ¹³C{¹H} NMR (CDCl₃, 125 MHz, 298 K): δ trans unit of the main chain: 130.34, δ cis unit of the main chain: 129.88, 32.63, 29.77 29.69, 29.24, 29.20, 29.07, 27.26, cyclocarbonate chain end: 69.51 (—CH═CH—CH—CH₂OCOO), 78.24 (—CH═CH—CH—CH₂OCOO), 123.89 (—CH═CH—CH—CH₂OCOO), 140.02 (—CH═CH—CH—CH₂OCOO), 155.10 (O═CO), vinyl chain end: 34.20 (—CH₂—CH═CH₂), 114.40 (—CH₂—CH═CH₂), 139.6 (—CH₂—CH═CH₂).

### Example 2

### Synthesis of a saturated polyolefin comprising a 2-oxo-1,3-dioxolan-4-yl end group by catalytic hydrogenation of the unsaturated polyolefin comprising a 2-oxo-1,3-dioxolan-4-yl end group of example 1

The reaction was carried out according to scheme 2 below.

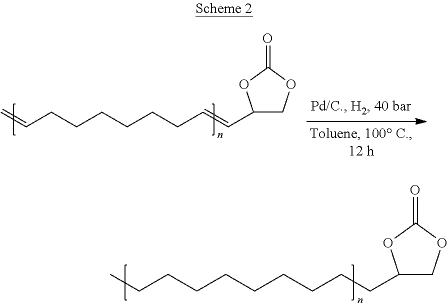

0.500 g of polymer (10) was introduced into 20 ml of toluene in a 50 ml reactor equipped with a magnetic bar, and then 0.05 g of Pd/C (10% by weight) catalyst was introduced. The reactor was brought to 40 bar (4 MPa) under hydrogen pressure and 100° C. for 12 hours. The mixture was subsequently cooled to ambient temperature and ventilated, and then the suspension was poured into methanol. The polymer was recovered by extraction with toluene under hot conditions. The solution was again poured into methanol and the precipitate, in the form of a white powder, was recovered by filtration and dried under vacuum at 40° C.

The hydrogenation of the double bonds was confirmed by H and ¹³C NMR.

### Example 3

### Use of the unsaturated polyolefin comprising a 2-oxo-1,3-dioxolan-4-yl end group of example 1 as reactive diluent

### Example 3a

### Synthesis of an unsaturated polyolefin (11) comprising two (2-oxo-1,3-dioxolan-4-yl)methyloxycarbonyl end groups

The formula (11) is as follows:

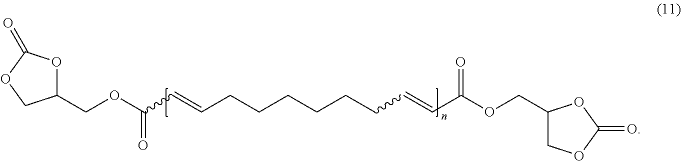

It was synthesized by ring opening metathesis polymerization between a chain transfer agent of formula (12) and cyclooctene.

Synthesis of (2-oxo-1,3-dioxolan-4-yl)methyl propenoate (chain transfer agent of formula (12), used for the synthesis of the polyolefin of formula (11))

The reaction was carried out according to the following scheme 3:

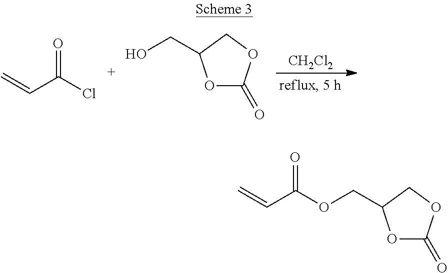

4.8 ml (5.7 g) of acryloyl chloride were added dropwise at room temperature to a solution of 7 g of glycerol carbonate in dry dichloromethane (15 ml). The resulting clear solution was slowly heated to 45° C. and subjected to reflux for an additional 5 hours. At the end of this period, the solution was cooled to ambient temperature and the solvent was removed by distillation. The crude oily product thus obtained was purified by distillation under vacuum. A clear and colorless product was obtained (yield 9.2 g, i.e. 90%). The NMR data of this product were as follows: ¹H NMR (CDCl₃, 298 K): δ=4.3-4.6 (4H, m, CH₂—CH—CH₂OCOO), 4.9 (1H, m, CH₂—CH—CH₂OCOO), 5.9 (1H, d, J_{HH}=10.7 Hz, CH₂═CH), 6.1 (1H, m, CH₂═CH), 6.4 (1H, d, J_{HH}=17.2 Hz, CH₂═CH). ¹³C{¹H} NMR (CDCl₃, 298 K): 6=63.2, 66.2 (CH₂-5CC), 74.0 (CH-5CC), 127.2 (CH₂═CH—), 132.5 (CH₂═CH—), 154.8 (O═COO), 165.5 (O═CO).

(2-Oxo-1,3-dioxolan-4-yl)methyl propenoate of formula (12):

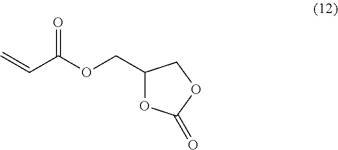

was thus obtained.

Synthesis of an unsaturated polyolefin of formula (11) comprising two (2-oxo-1,3-dioxolan-4-yl)methyloxycarbonyl end groups from cyclooctene (COE) and the (2-oxo-1,3-dioxolan-4-yl)methyl propenoate chain transfer agent (CTA) of formula (12) synthesized above

The reaction was carried out according to the following scheme 4:

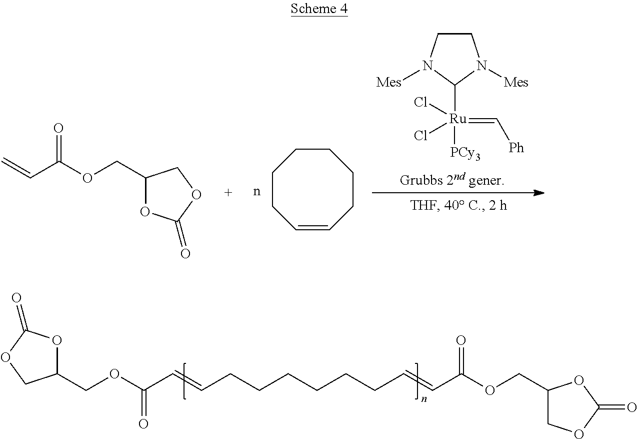

It made it possible to obtain the polyolefin of formula (11).

The polymerization, the conditions of which are summarized in table 2, was carried out according to the data below. A 100 ml flask was charged, with stirring and sequentially, with THF (tetrahydrofuran) (5 ml), COE (1.4 ml) and the appropriate amount of (2-oxo-1,3-dioxolan-4-yl)methyl 2-propenoate transfer agent. The resulting solution was thermostatically controlled at 40° C. and the polymerization was initiated by injection of a precatalyst solution prepared by dissolving a 2^{nd} generation Grubbs' catalyst (“Ru”) (5.0 mg) in THF (3 ml). After reacting for two hours, the mixture was poured into cold acidified methanol. The polymers present were recovered by filtration and dried at 25° C. under vacuum.

TABLE 2

| | [CTA]/[Ru] | [COE]/[CTA] | Conv. | Mn_{GPC} | |
|---|---|---|---|---|---|
| | (mol/mol) | (mol/mol) | (%) | (g/mol) | PDI |
| Test | 50 | 40 | 100 | 12 200 | 1.69 |

The compound of formula (11) was thus synthesized. This is because NMR analyses of the polymer obtained gave the following values, which confirm the structural formula (11) of this polymer. ¹H NMR (CDCl₃, 500 MHz, 298 K)—trans repeat unit: 1.30, 1.97, 5.39; cis repeat unit: 1.30, 2.03, 5.34; end group: 2.25 (m, 2H, —CH₂—CH═CH—COO), 4.30, 4.63 (m, 4H, —CH₂—CH—CH₂OCOO), 4.96 (m, 1H, —CH₂—CH—CH₂OCOO), 5.87 (d, Jₜᵣₐₙₛ=15.2 Hz, 1H, —CH═CH—COO), 7.07 (m, 1H, —CH═CH—COO, Jₜᵣₐₙₛ=15.0 Hz, J=7.0 Hz). ¹³C NMR (CDCl₃, 125 MHz, 298 K)—repeat unit: 130.34 (trans), repeat unit: 129.88 (cis), 32.63, 29.77, 29.69, 29.24, 29.20, 29.07, 27.26; end group: 62.80, 66.0 (—CH₂—CH—CH₂OCOO), 73.87 (—CH₂—CH—CH₂OCOO), 119.50 (—CH═CH—COO—), 152.04 (—CH═CH—COO), 154.6 (O═COO), 165.9 (OC=0).

### Example 3b

### Use of the unsaturated polyolefin of formula (10) comprising a 2-oxo-1,3-dioxolan-4-yl end group of example 1 as reactive diluent

A 90/10 by weight mixture of unsaturated polyolefin (11) and of unsaturated polyolefin (10) according to the invention comprising a single 2-oxo-1,3-dioxolan-4-yl end group:

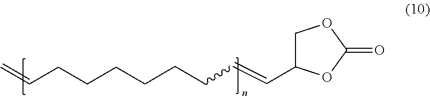

was reacted at 80° C. with a di(primary amine) of polyether diamine type (Jeffamine EDR 176, Huntsman) in an NH₂/total CC5 stoichiometric ratio, until complete disappearance of the infrared band characteristic of the 1,3-dioxolan-2-one groups (at 1800 cm⁻¹) and the appearance of the bands characteristic of the carbamate group (band at 1700 cm⁻¹). The duration of the reaction was approximately 12 hours.

The compound of formula (10) according to the invention acted as reactive diluent.

The product thus synthesized resulted in the formation of polyurethane, which two-component mixture, appropriately formulated, made it possible to obtain adhesive properties.

1. A process for the preparation of at least one hydrocarbon polymer, said process comprising at least one stage of ring opening metathesis polymerization in the presence:
of at least one metathesis catalyst, preferably a ruthenium-comprising catalyst, more preferably still a Grubbs' catalyst,
of 4-ethenyl-1,3-dioxolan-2-one (or vinyl ethylene carbonate) as chain transfer agent (CTA), and
at least one compound chosen from compounds comprising at least one hydrocarbon ring and generally from 6 to 16, preferably from 6 to 12, carbon atoms per ring, said ring comprising at least one carbon-carbon double bond, and the substituted derivatives of this compound, said compound generally being of formula (7): 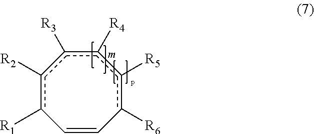
each carbon-carbon bond of the chain denoted [symbol] is a double bond or a single bond, in accord with the valency rules of organic chemistry;
the R₁ and R₆ groups are either both hydrogen or each different from hydrogen and bonded to one another as members of one and the same ring or heterocycle which is saturated or unsaturated;
the R₂, R₃, R₄ and R₅ groups are each, independently or not of the other groups, a hydrogen, a halo group, an alkoxycarbonyl group or an alkyl group, it being possible for the R₂ to R₅ groups to be bonded to one another as members of one and the same saturated or unsaturated ring or heterocycle;
m and p are integers each within a range extending from 0 to 5, the sum m+p being itself within a range from 0 to 6;
said stage being carried out for a period of time of less than or equal to 2 h, preferably from 1 hour to 2 hours.

2. The process for the preparation of at least one hydrocarbon polymer as claimed in claim 1, said process additionally comprising at least one additional stage of hydrogenation of carbon-carbon double bonds.

3. A hydrocarbon polymer comprising a 2-oxo-1,3-dioxolan-4-yl end group, said polymer being capable of being obtained by the preparation process as claimed in claim 1.

4. The hydrocarbon polymer comprising a 2-oxo-1,3-dioxolan-4-yl end group as claimed in claim 3, said hydrocarbon polymer being of formula (1): 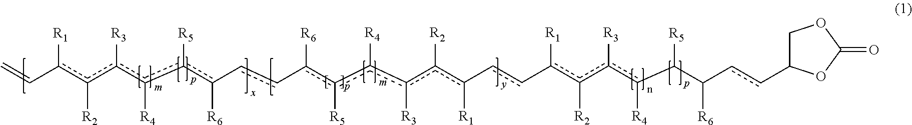
in which:
each carbon-carbon bond of the chain denoted [symbol] is a double bond or a single bond, in accord with the valency rules of organic chemistry;
the R₁ and R₆ groups are either both hydrogen or each different from hydrogen and bonded to one another as members of one and the same ring or heterocycle which is saturated or unsaturated;
the R₂, R₃, R₄ and R₅ groups are each, independently or not of the other groups, a hydrogen, a halo group, an alkoxycarbonyl group or an alkyl group, it being possible for the R₂ to R₅ groups to be bonded to one another as members of one and the same saturated or unsaturated ring or heterocycle;
m and p are integers each within a range extending from 0 to 5, the sum m+p being itself within a range from 0 to 6; and
x and y are each an integer, independently of one another, x being different from 0, the sum x+y being such that the number-average molar mass Mn of the hydrocarbon polymer of formula (1) is within a range from 400 to 50 000 g/mol, preferably from 600 to 20 000 g/mol, and the polydispersity (PDI) of the hydrocarbon polymer of formula (1) is within a range from 1.0 to 2.0, preferably from 1.1 to 1.7 and more preferably still from 1.4 to 1.7.

5. The hydrocarbon polymer comprising a 2-oxo-1,3-dioxolan-4-yl end group as claimed in claim 4, said hydrocarbon polymer being of formula (2) or of formula (3): 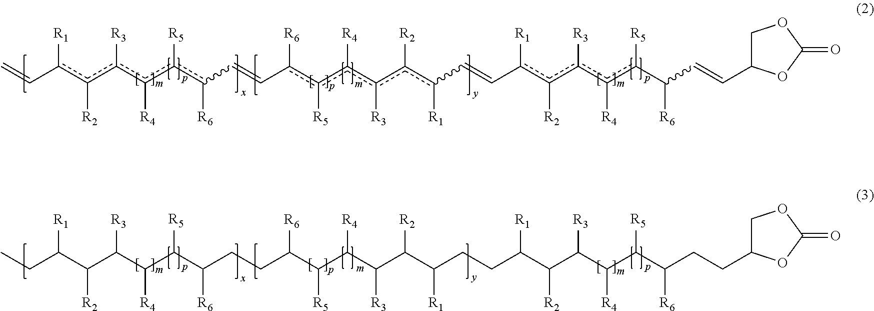
in which [symbol] , m, p, x, y, R₁, R₂, R₃, R₄, R₅ and R₆ have the meanings given in claim 4 and the [symbol] bond means that the bond is oriented geometrically on one side or the other with respect to the double bond (cis or trans).

6. The hydrocarbon polymer comprising a 2-oxo-1,3-dioxolan-4-yl end group as claimed in claim 4, said hydrocarbon polymer being of formula (4): 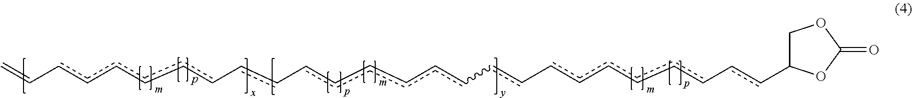
in which [symbol] , m, p, x and y have the meanings given in claim 4.

7. The hydrocarbon polymer comprising a 2-oxo-1,3-dioxolan-4-yl end group as claimed in claim 5, said hydrocarbon polymer being of formula (5) or of formula (6):

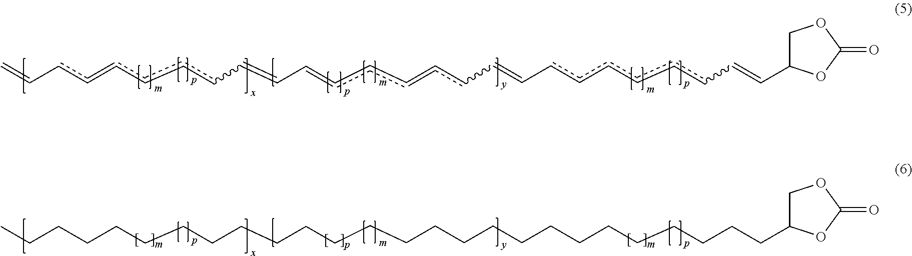

8. An adhesive composition comprising at least one hydrocarbon polymer as claimed in claim 3 as an adhesion promoter.

9. An adhesive composition comprising at least one hydrocarbon polymer as claimed in claim 3 as a reactive plasticizer.
